(19) United States
(12) Patent Application Publication
(10) Pub. No.: US 2007/0278854 A1
(43) Pub. Date: Dec. 6, 2007

(54) Pressurized Medium Consumer Device

(76) Inventor: Heinrich Diekmeyer, Barsinghausen (DE)

Correspondence Address: KRAMER LEVIN NAFTALIS & FRANKEL LLP;INTELLECTUAL PROPERTY DEPARTMENT, 1177 AVENUE OF THE AMERICAS, NEW YORK, NY, 10036, US

(21) Appl. No.: 10/566,074

(22) PCT Filed: Jul. 12, 2004
(86) PCT No.: PCT/EP04/07647

§ 371 Date: Apr. 2, 2007

(30) Foreign Application Priority Data
Jul. 28, 2003 (DE) 103 34 315.6
Jan. 14, 2004 (DE) 10 2004 001 917.7

(51) Int. Cl. B60T 17/06

(52) U.S. Cl. 303/66

(57) ABSTRACT

A pressurized-fluid-consuming system includes secondary pressurized-fluid consumer devices for drawing pressurized fluid from at least one pressurized-fluid storage reservoir which also supplies additional pressurized-fluid-consuming devices. The secondary consumer devices receive a value of state of the at least one pressurized-fluid storage reservoir and draws pressurized fluid therefrom only if the value of state reaches a predetermined minimum value.

### BACKGROUND OF THE INVENTION

The present invention relates to an improved pressurized-fluid consuming system employing pressurized-fluid consuming devices.

In the automotive engineering field, pressurized-fluid consuming devices are conventionally employed in, for example, service-brake systems, trailer-brake systems, parking-brake systems or air-suspension systems. Such devices draw pressurized fluid from one or, frequently, from a plurality of pressurized-fluid storage reservoirs. To fill a pressurized-fluid storage reservoir with pressurized fluid, a pressurized-fluid supply device is typically provided. When compressed air, for example, is used as the pressurized fluid, the pressurized-fluid supply device is provided in known manner with a compressor, an air dryer, a pressure regulator and, for separation of individual compressed air circuits, a multi-circuit protective valve. Such a compressed-air supply device can also be equipped with an electronic controller, as described, for example, in DE 100 04 091 C2. The electronic controller assumes the functions of the pressure regulator and of the conventional multi-circuit protective valve in conjunction with suitable sensors and actuators. That is, the electronic controller serves a multi-circuit protective function.

When pressurized-fluid consuming devices of the type noted above are used in a vehicle, safety reasons dictate that any such devices whose availability does not influence, or only slightly influences, operation of the vehicle in a manner critical to safety cannot affect the function of other pressurized-fluid consuming devices whose availability influences operation of the vehicle in a manner critical to safety (e.g., through rapid pressurized-fluid consumption). The brake system of a vehicle is an example of a system employing pressurized-fluid consuming devices having consequences that are particularly critical to safety if the availability of such devices is limited; and an air-suspension system is an example of a system employing pressurized-fluid consuming devices having consequences that are only slightly critical to safety.

In the case of vehicles with a compressed air brake system, in conformity with EU Directive 98/12, certain groups of compressed air-consuming devices are provided with their own compressed air storage reservoir. Normally, for example, the brake system uses one compressed air storage reservoir for the front-axle brake circuit and a separate compressed air storage reservoir for the rear-axle brake circuit. In addition, separate compressed air storage reservoirs are provided for each of the other compressed air consumers, such as, for example, the air-suspension system. The intention is to ensure that the secondary consumers identified in EU Directive 98/12, that is, those consumers such as the air-suspension system that do not belong to the service-brake system of the vehicle, do not undesirably reduce the compressed air reserves stored in the compressed air storage reservoirs of the service-brake system to such an extent that, by their operation, adequate braking capacity of the vehicle is jeopardized. The known approach of providing separate compressed air storage reservoirs for a plurality of compressed air circuits is associated with high costs and great complexity of the compressed air system in a vehicle.

### SUMMARY OF THE INVENTION

Generally speaking, in accordance with the present invention, an improved pressurized-fluid consuming system is provided that overcomes disadvantages associated with conventional systems.

The present invention has the advantage that, by use of a pressurized-fluid consuming device as a secondary consumer, it is possible to dispense with a separate pressurized-fluid storage reservoir for this secondary consumer. To supply the pressurized-fluid consuming device with pressurized fluid, it can then be simply connected, via a multi-circuit protective function used for decoupling the individual pressurized-fluid circuits in the manner of a multi-circuit protective valve of conventional type, to other pressurized-fluid storage reservoirs, such as the pressurized-fluid storage reservoirs of the service-brake system, which are present in any case (for example, to satisfy EU Directive 98/12). As a result, the costs associated with the eliminated pressurized-fluid storage reservoir as well as for corresponding pressurized-fluid lines needed for connection thereof can be saved. In addition, cost and time with respect to installation of the pressurized-fluid system can be saved. A further advantage is that the regulations of EU Directive 98/12 are automatically satisfied (the inventive pressurized-fluid consuming system automatically ensures compliance with these regulations, without the need to take further provisions into consideration in designing the pressurized-fluid system of the vehicle). A further advantage is that overflow valves that may have been present together with such secondary consumers can be dispensed with.

In one embodiment of the present invention, several physical variables, such as the pressure in the pressurized-fluid storage reservoir or the quantity of air contained therein or the mass of air contained therein or the energy stored therein can be used as a value of state. This has the advantage that a physical variable that may have already been determined by means of sensors for other purposes can be used by the inventive pressurized fluid-consuming system. The use of pressure as the value of state has the advantage that a pressure sensor can be used for sensing, an approach which is relatively inexpensive.

Still other objects and advantages of the present invention will in part be obvious and will in part be apparent from the specification.

The present invention accordingly comprises the features of construction, combination of elements, and arrangement of parts which will be exemplified in the constructions hereinafter set forth, and the scope of the invention will be indicated in the claims.

### BRIEF DESCRIPTION OF THE DRAWINGS

The present invention will be described in more detail hereinafter and further advantages will be pointed out on the basis of the accompanying drawing, wherein:

FIG. 1 is a schematic diagram of a pressurized-fluid system with pressurized-fluid consuming devices in accordance with an embodiment of the present invention.

### DETAILED DESCRIPTION OF THE PREFERRED EMBODIMENTS

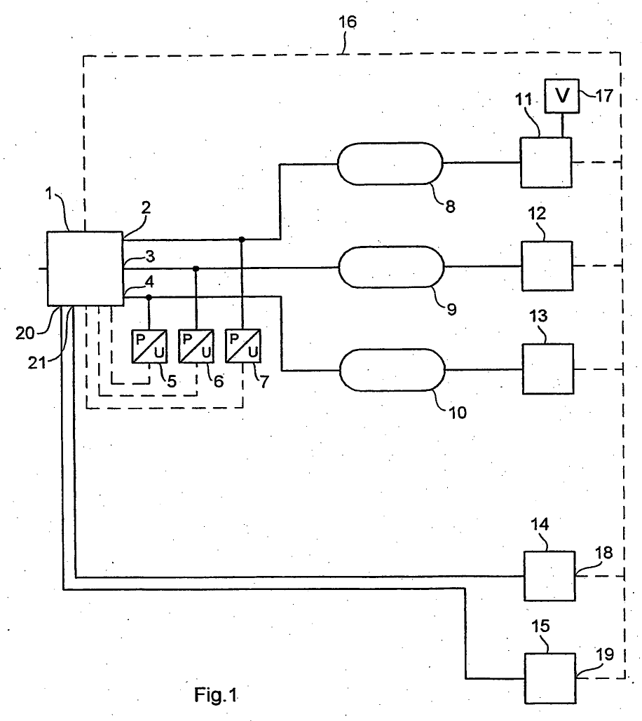

Referring now to FIG. 1, where pressurized-fluid lines are represented by solid lines and electrical lines by broken lines there is shown a pressurized-fluid supply device (1) with pressurized-fluid discharge ports (2, 3, 4), which are in communication with pressurized-fluid storage reservoirs (8, 9, 10) via pressurized-fluid lines. Pressurized-fluid consuming devices (11, 12, 13) are provided in communication with pressurized-fluid storage reservoirs (8, 9, 10) via pressurized-fluid lines. The pressurized-fluid consuming devices (11, 12, 13) can be, for example, a service-brake circuit of the front axle, a service-brake circuit of the rear axle and a brake circuit for a trailer, respectively.

Pressurized-fluid supply device (1) is provided with a multi-circuit protective function, which is used for decoupling the pressurized-fluid circuits (11, 12, 13) and which satisfies the function of a known multi-circuit protective valve. Such a multi-circuit protective function as well as a specific configuration containing pneumatic valves is described, for example, in DE 196 22 095 A1.

Pressurized-fluid supply device (1) is provided with further pressurized-fluid discharge ports (20, 21), to which there are respectively connected, via respective pressurized-fluid lines, a first pressurized-fluid consuming device (14) and a second pressurized-fluid-consuming device (15). First pressurized-fluid consuming device (14) can be placed in communication with pressurized-fluid storage reservoir (9) via the multi-circuit protective function, and second pressurized-fluid consuming device (15) can be placed in communication with pressurized-fluid storage reservoir (8) via the multi-circuit protective function. Pressurized-fluid consuming devices (14) or (15) can be designed, for example, as vehicle level-control systems.

According to one embodiment of the present invention, pressurized-fluid supply device (1) and, if necessary, pressurized-fluid consuming devices (11, 12, 13) are each provided with an electronic controller as well as with a port for a data bus. The data-bus ports can be connected to one another via a data bus (16), such as, for example, a controller area network (“CAN”) bus.

Each of first and second pressurized-fluid consuming devices (14, 15) can also be equipped with an electronic controller and with a data bus port (18, 19). Devices (1, 11, 12, 13, 14, 15) can exchange data with one another over data bus (16).

Pressurized-fluid supply device (1) is connected via electrical lines to pressure sensors (5, 6, 7), each of which is in pneumatic communication with pressurized-fluid storage reservoirs (8, 9, 10). The sensors sense the respective pressures in pressurized-fluid storage reservoirs (8, 9, 10) and transmit this information as pressure signals to pressurized-fluid supply device (1). Pressure sensors (5, 6, 7) can also be integrated into pressurized-fluid supply device (1). Pressurized-fluid supply device (1) transmits the pressure signals of pressure sensors (5, 6, 7) over data bus (16).

It is also advantageous to connect pressure sensors (5, 6, 7) via the electrical lines to another device in the vehicle, such as an electronics unit of the instrument panel. In compressed air braked motor vehicles, it is customary to mount indicator instruments in the instrument panel for indication of the pressure present in pressurized-fluid storage reservoirs (8, 9, 10), so as to inform the operator of the motor vehicle about the current pressure values. For this purpose, the instrument panel, or the electronics unit of the instrument panel used to control indicator functions of the instrument panel, is connected to the pressure sensors. Preferably, the electronics unit of the instrument panel is designed such that it is also connected to data bus (16) and transmits the pressure signals of pressure sensors (5, 6, 7) over data bus (16) to pressurized-fluid supply device (1) and, if necessary, to other receiving devices.

Preferably, first and second pressurized-fluid consuming devices (14, 15) are constructed and arranged to receive pressure signals from data bus (16).

According to an advantageous embodiment of the present invention, pressurized-fluid consuming device (1), or the electronics unit of the vehicle instrument panel, transmits the pressure values determined by pressure sensors (5, 6, 7) onto data bus (16) in the form of pressure signals of the respective pressurized-fluid storage reservoirs (8, 9, 10). First and second pressurized-fluid consuming devices (14, 15) receive and evaluate these pressure signals. Predetermined minimum pressure values are programmed into first and second pressurized-fluid consuming devices (14, 15). These predetermined values are compared against respective received pressure signals. For this purpose, microprocessors that execute a resident program are provided in the electronic controllers of first and second pressurized-fluid consuming devices (14, 15). During execution of the program, the comparison of the predetermined minimum pressure value and the received pressure signals is performed.

If, during this process, the pressure value indicated by the pressure signal is below the predetermined minimum pressure value, the electronic controllers of pressurized-fluid consuming devices (14, 15) prevent pressurized-fluid consuming devices (14, 15) from drawing any pressurized fluid from respective pressurized-fluid storage reservoir (8, 9). Only when the predetermined minimum pressure value is reached or exceeded do the electronic controllers permit the drawing of pressurized fluid on demand. The other functions of pressurized-fluid consuming devices (14, 15) that can be performed even without drawing of pressurized fluid are performed even when the pressures are below the minimum value.

Pressurized-fluid consuming device (11) is also connected via an electrical line to a speed sensor (17). The travel speed of the vehicle can be determined from the signal of the speed sensor. Pressurized-fluid consuming device (11) receives the signal of speed sensor (17) and transmits a speed signal corresponding to this value of speed onto data bus (16). First and second pressurized-fluid consuming devices (14, 15) receive and evaluate the speed signal from data bus (16). If a vehicle speed slower than a predetermined minimum speed value is detected, for example close to vehicle standstill, first and second pressurized-fluid consuming devices (14, 15) then draw pressurized-fluid from pressurized-fluid storage reservoirs (8, 9) on demand even if the pressure is below the predetermined minimum value.

It will thus be seen that the objects set forth above, among those made apparent from the preceding description, are efficiently attained, and since certain changes may be made in the above constructions without departing from the spirit and scope of the invention, it is intended that all matter contained in the above description or shown in the accompanying drawings shall be interpreted as illustrative and not in a limiting sense.

It is also to be understood that the following claims are intended to cover all of the generic and specific features of the invention herein described and all statements of the scope of the invention which, as a matter of language, might be said to fall therebetween.

What is claimed is:

1. A pressurized-fluid-consuming system, comprising at least one pressurized-fluid consuming device and at least one secondary consumer device, said at least one secondary consumer device being constructed and arranged to draw pressurized fluid from at least one pressurized-fluid storage reservoir said at least one pressurized-fluid storage reservoir being constructed and arranged to supply said at least one pressurized-fluid-consuming devices said at least one secondary consumer device including means for receiving a determined value of state of said at least one pressurized-fluid storage reservoir and for drawing pressurized fluid from said at least one pressurized-fluid storage reservoir only when said value of state reaches a predetermined minimum value.

2. The pressurized-fluid-consuming system according to claim 1, wherein said value of state indicates at least one of (i) pressure in said at least one pressurized-fluid storage reservoir and (ii) quantity of air contained therein and (iii) mass of air contained therein and (iv) energy stored therein.

3. The pressurized-fluid-consuming system according to claim 1, wherein said secondary consumer device draws pressurized fluid from said at least one pressurized-fluid storage reservoir only when said value of state is within a predetermined range.

4. The pressurized-fluid-consuming system according to claim 1, wherein said at least one pressurized-fluid-consuming devices includes at least one vehicle brake system.

5. The pressurized-fluid-consuming system according to claim 1, wherein said at least one secondary consumer device includes at least one port for connection to a data bus and means for receiving a signal indicating said value of state from said data bus.

6. The pressurized-fluid-consuming system according to claim 1, further comprising a pressurized-fluid supply device for filling said at least one pressurized-fluid storage reservoir, and wherein said signal indicating said value of state is transmitted by at least one of said pressurized-fluid supply device and an electronics unit of an instrument panel.

7. The pressurized-fluid-consuming system according to claim 1, wherein said at least one secondary consumer device is constructed and arranged for use in a vehicle, said at least one secondary consumer device including means for receiving a speed signal indicating vehicle speed, and, when said speed signal is less than a predetermined value of speed, drawing pressurized-fluid from said at least one pressurized-fluid storage reservoirs on demand even when said value of state has not reached said predetermined minimum value.

8. The pressurized-fluid-consuming system according to claim 1, wherein said at least one secondary consumer device is a vehicle level-control system.

9. The pressurized-fluid consuming system according to claim 4, wherein said at least one vehicle brake system is a service brake system.
